(19) United States
(12) Patent Application Publication
(10) Pub. No.: US 2012/0103057 A1
(43) Pub. Date: May 3, 2012

(54) PARTICULATE MATTER DETECTION SENSOR

(75) Inventors: Takehito KIMATA, Kariya-shi (JP); Takehiro Watarai, Kuwana-shi (JP)

(73) Assignee: DENSO CORPORATION, Kariya-city (JP)

(21) Appl. No.: 13/282,684

(22) Filed: Oct. 27, 2011

(30) Foreign Application Priority Data
Oct. 28, 2010 (JP) 2010-242138

(51) Int. Cl. G01M 15/10

(52) U.S. Cl. 73/23.33

(57) ABSTRACT

In a PM detection sensor, a gas introduction hole is formed in a cover unit which surrounds a PM detection element. The gas introduction hole faces a detection part having detection electrodes of a comb structure. A projected part generated when an opening part of the gas introduction hole is projected on the detection part is within an inside area of the detection part. The projected area of the opening part of the gas introduction hole is positioned within the inside area having a uniform electric field intensity between the detection electrodes. The target detection gas is directly introduced through the gas introduction hole to the area having the uniform electric field intensity generated on the detection part. PM contained in the target detection gas is captured and accumulated on the area having the uniform electric field intensity but not on the area having non-uniform electric field intensity.

### CROSS-REFERENCE TO RELATED APPLICATION

This application is related to and claims priority from Japanese Patent Application No. 2010-242138 filed on Oct. 28, 2010, the contents of which are hereby incorporated by reference.

### BACKGROUND OF THE INVENTION

1. Field of the Invention

The present invention relates to particulate matter detection sensors mounted to an exhaust gas purifying system for an internal combustion engine of a motor vehicle, and are capable of detecting particulate matter contained in target detection gas such as exhaust gas emitted from the internal combustion engine.

2. Description of the Related Art

In general, a diesel engine, for example, mounted to a motor vehicle, is equipped with a diesel particulate filter (hereinafter, referred to as the “DPF”). Such a DPF captures particulate matters (hereinafter, referred to as the “PM” for short) as environmental pollution matter contained in exhaust gas emitted from the diesel engine. The PM contains soot and soluble organic fraction (SOF). The DPF is composed of a plurality of cells surrounded by partition walls having a plurality of pores. When the exhaust gas passes through the pores formed in the partition walls, the pores capture PM contained in the exhaust gas. The exhaust gas is thereby purified.

When a quantity of PM captured in the pores formed in the partition walls in the DPF is increased, the pores are clogged and a pressure loss of the DPF is thereby increased. In order to avoid this and to regenerate the capturing function of the DPF, it is necessary to periodically execute a process of regenerating the DPF.

In general, the regeneration cycle of the DPF is determined on the basis of detecting a quantity of PM captured in the DPF. It is therefore necessary to place a pressure sensor capable of detecting a difference between a pressure at an upstream side and a pressure downstream side of the DPF. The regeneration process heats the exhaust gas or executes a post injection in order to heat the exhaust gas, and introduces the heated exhaust gas into the inside of the DPF. This removes PM captured in the pores formed in the partition walls of the DPF.

On the other hand, there have been proposed various types of particulate matter detection sensors (hereinafter, referred to as the “PM detection sensor”) capable of directly detecting the presence of PM contained in exhaust gas. For example, such a PM sensor is placed at the downstream side of the DPF, and detects a quantity of PM contained in the exhaust gas passing through the DPF. An on-board diagnosis mounted to a motor vehicle monitors the output of the PM sensor in order to detect the working condition of the DPF, and occurrence of defects and damage of the DPF.

It has also been proposed to place such a PM sensor, instead of using a pressure difference sensor, at the upstream side of the DPF, and to detect a quantity of exhaust gas introduced into the DPF. This can determine the optimum time of regenerating the DPF on the basis of the detected quantity of PM.

A conventional patent document 1, a Japanese patent laid open publication No. S59-197847, has disclosed a smoke sensor of an electrical resistance type as one example of the above PM sensor. The smoke sensor is comprised of an insulation substrate, a pair of conductive electrodes as a detection part, and a heating unit. The pair of conductive electrodes is formed on one surface of the insulation substrate, and the heating unit is formed in the inside or the bottom surface of the insulation substrate.

The smoke sensor detects the presence of smoke (particulate carbon) in exhaust gas on the basis of using electrical conductivity of the smoke. The smoke sensor detects the change of a resistance value between the conductive electrodes, which is changed according to the quantity of smoke accumulated on the area between the conductive electrodes.

The heating unit generates heat energy when receiving electric power. The heat energy increases a temperature of the PM detection part to a desired temperature (for example, a temperature within a range of 400° C. to 600° C.), and burns the smoke accumulated on the area between the conductive electrodes. This makes it possible to recover the detection capability of the smoke sensor.

Other conventional patent document 2, a German patent application No. DE 102006015385, has disclosed a detection device and a detection method. The detection device is comprised of a plurality of cover units and a detection element. The detection element has detection electrodes formed in parallel to the longitudinal axis of the detection device. The cover units cover the detection element having the detection electrodes. Target detection gas such as exhaust gas is introduced from a back surface of the detection element into the inside of the detection device. The detection method shifts the flowing direction of the target detection gas toward the axial direction of the detection element so that the flow of the target detection gas becomes in parallel to the detection electrodes (see the description and FIG. 1 and FIG. 2 of the conventional patent document 2).

Other conventional patent document 3, Kohyo (National publication of translated version) No. JP 2008-502892, has disclosed a technique of changing a voltage supplied between detection electrodes formed in a comb structure, of increasing an electric field intensity generated between the detection electrodes by applying a high voltage during a detection initial period in order to promote the accumulation speed of PM on the area between the detection electrodes. The method decreases a dead time period of the detection electrodes. During the dead time period, the detection electrodes cannot output any detection signal. After completion of the dead time period of the detection electrodes, the method decreases the electric field intensity between the detection electrodes in order to decrease the speed of accumulating PM on the area between the detection electrodes. This makes it possible to prolong the period to execute the regeneration process.

By the way, the technique disclosed in the conventional patent document 2 previously described has a complicated gas-flowing path and makes it difficult to execute correct introduction of exhaust gas containing PM to the detection element without using an additional member. Using the additional member causes a complicated sensor structure and increases the manufacturing cost of the detection device.

Further, such a complicated structure of the gas-flowing path causes a problem of accumulating PM on the area other than the detection part in which the detection electrodes are formed. There is a possibility of it being difficult to rapidly detect a quantity of PM contained in the target detection gas with high accuracy.

When a voltage is supplied between the detection electrodes formed in a comb structure, the electric field intensity is increased at the front part of each detection electrode because the electric field is concentrated at the front part of each detection electrode. On the other hand, the electric field intensity is decreased at the bottom part of each detection electrode, which is connected in a direction which is perpendicular to a corresponding detection electrode lead part. This causes non-uniform electric field generated between the detection electrodes.

When non-uniform electric field intensity is generated, it is difficult to have a constant PM accumulation speed, and the PM accumulation speed is fluctuated during a dead time period. In particular, as disclosed in the conventional patent document 2, when increasing the quantity of the PM accumulation by increasing the magnitude of the supplied voltage, the fluctuation of the electric field intensity causes PM to be more accumulated on the area having a high electric field intensity, and PM to be less accumulated on the area having a low electric field intensity. This increases the difference in quantity of accumulated PM between the areas having the different electric field intensity, and increases the fluctuation of the dead time period. When the fluctuation of the dead time period is increased, the PM sensor outputs an incorrect detection. This decreases the reliability of the PM sensor.

Further, when the PM sensor is fixed to the exhaust gas path through which the target detection gas flows, a correct position of the detection element in the circumferential direction is not fixed, and the target detection gas is introduced into the inside of the PM sensor from a variable direction, and a plurality of openings is formed at a constant interval at the side surface of the cover unit in order to protect the detection element. This structure causes the output of the PM sensor to be fluctuated according to the direction along which the detection element is fixed.

### SUMMARY

It is therefore desired to provide a particulate matter detection sensor equipped with a particulate matter detection element having a stable dead time period with high reliability, capable of detecting a quantity of particulate matter contained in a target detection gas on the basis of electrical characteristics of an area between a pair of detection electrodes formed on a detection part in the particulate matter detection element with a simple structure. The electrical characteristics of the area between the pair of the detection electrodes are changed on the basis of the quantity of particulate matter accumulated on the area between the pair of detection electrodes with a simple configuration.

A present exemplary embodiment provides a particulate matter detection sensor capable of detecting particulate matter contained in a target detection gas. The particulate matter detection sensor has a heat resistance substrate, a detection part and a cover unit. The detection part has a pair of detection electrodes formed at a predetermined interval on a surface of the heat resistant substrate. The cover unit has a target detection gas introduction hole through which the target detection gas is introduced into the detection part while protecting the detection part. In the particulate matter detection sensor, particulate matter contained in the target gas is captured on the detection part by electrostatic force generated between the detection electrodes. The presence of particulate matter contained in the target detection gas is detected on the basis of a change of electric characteristics of the detection part when particulate matter is accumulated on an area between the detection electrodes in the detection part. The target detection gas introduction hole is formed in the cover unit so that a projected area of the target detection gas introduction hole on the detection part generated when the target detection gas introduction hole is projected onto the detection part is positioned within the inside of an area having a uniform electric field intensity generated between the pair of the detection electrodes.

When particulate matter contained in the target detection gas is introduced onto the detection part, the structure of the particulate matter detection sensor according to the exemplary embodiment prevents the target detection gas from reaching the area having non-uniform electric field intensity between the detection electrodes at the outside of the projected area of the target detection gas introduction hole, and makes it possible to supply the target detection gas onto the area having the uniform electric field intensity between the detection electrode on the detection part. This structure makes it possible to suppress and avoid particulate matter from being locally accumulated on the area having non-uniform electric field intensity between the detection electrodes, and to prolong the necessary period of time to execute a process of regenerating the particulate matter detection sensor because of obtaining a stable dead time period and avoiding an excess accumulation of particulate matter on the detection part.

In the particulate matter detection sensor according to the exemplary embodiment, the pair of the detection electrodes has one of structures (a) and (b): (a) the detection electrodes have a comb structure in which electrodes are alternately arranged in parallel along a longitudinal direction of the heat resistant substrate, and are formed along a direction which is perpendicular to a pair of detection electrode lead parts, and the detection electrode lead parts are connected to an external detection circuit; and (b) the detection electrodes have a comb structure in which electrodes are alternately arranged in parallel along a longitudinal direction of the heat resistant substrate, and the plural electrodes are connected to a bent part of each of a pair of detection electrode lead parts, and the bent part of each of the detection electrode lead parts is bent in a direction which is perpendicular to the longitudinal direction of the heat resistant substrate, and the detection electrode lead parts are connected to an external detection circuit. The projected area of the target detection gas introduction hole projected on the detection part is positioned within the inside of an area formed by a front part of one detection electrode and the connection part between the other detection electrode and the corresponding detection electrode lead part so that the target detection gas is introduced onto the area in which straight line parts of the detection electrodes are arranged in parallel.

According to the exemplary embodiment, because the target detection gas introduction hole is open to the inside area having the uniform electric field intensity generated in the detection part. The target detection gas is introduced through the target detection gas introduction hole directly to the detection part. Particulate matter contained in the introduced target detection gas is accumulated only on the area having the uniform electric field intensity. This structure makes it possible to suppress and avoid particulate matter from being locally accumulated on the area having non-uniform electric field intensity. This makes it possible to avoid a conductive path from being made on the detection part by the locally accumulated particulate matter, and to avoid undetectable state of the particulate matter detection sensor, and to suppress incorrect operation of the particulate matter detection sensor.

According to the present exemplary embodiment, the pair of the detection electrodes is formed extending in parallel on the heat resistant substrate at a predetermined interval along the longitudinal direction of the heat resistant substrate. At least the inside area between the pair of the detection electrodes is used as the detection part. One end part of each of the detection electrodes is bent. The bent part of each of the detection electrodes is connected to a corresponding detection electrode lead part. The pair of the detection electrode lead parts is formed at the outside of the pair of the detection electrodes formed in parallel on the heat resistant substrate. The pair of the detection electrode lead parts is connected to an external detection circuit. The projected area of the target detection gas introduction hole generated when the target detection gas introduction hole is projected onto the detection part is positioned within the inside of an area surrounded by straight line parts of the pair of the detection electrodes excepting the bent part of each of the detection electrodes and the pair of the detection electrode lead parts. The target detection gas is introduced into the inside of the straight line parts of the detection electrode formed in parallel.

According to the present exemplary embodiment, because the target detection gas is introduced onto the area having the uniform electric field intensity within the inside of the straight line part of the detection electrodes formed in parallel on the heat resistance substrate. This makes it possible to provide the particulate matter detection sensor capable of outputting stable sensor output with high accuracy.

### BRIEF DESCRIPTION OF THE DRAWINGS

A preferred, non-limiting embodiment of the present invention will be described by way of example with reference to the accompanying drawings, in which:

FIG. 1A is a view showing a schematic cross section of a main part of a particulate matter detection sensor according to a first exemplary embodiment of the present invention;

FIG. 1B is a view showing a schematic cross section of a part of the particulate matter detection sensor according to the first exemplary embodiment of the present invention;

FIG. 1C is a view showing a cross section of the particulate matter detection sensor along the A-A line shown in FIG. 1B;

FIG. 2 is a development view showing a perspective structure of a detection element in the PM detection sensor according to the first exemplary embodiment of the present invention;

FIG. 3 is a schematic view showing equipotential lines and electric lines of force in the detection part of the PM detection sensor according to the first exemplary embodiment of the present invention;

FIG. 4 is a schematic view showing a distribution of electric field intensity in the detection part of the PM detection sensor according to the first exemplary embodiment of the present invention;

FIG. 5 is a view showing results of analyzing electric field vectors, by finite element solution, generated in the detection part of the PM detection element according to the first exemplary embodiment of the present invention;

FIG. 6A is a schematic view showing PM accumulated on the detection part during a dead time period of the PM detection sensor according to the exemplary embodiment of the present invention;

FIG. 6B is a schematic view showing PM accumulated on the detection part at a completion of a detection period of the PM detection sensor according to the exemplary embodiment of the present invention;

FIG. 6C is a schematic view showing PM accumulated on a detection part of a PM detection sensor as a comparison example;

FIG. 6D is a schematic view showing PM accumulated on the detection part at a completion of a detection period of the PM detection sensor as the comparison example;

FIG. 7A is a view showing a characteristic change of a sensor output supplied from the PM detection sensor with passage of time;

FIG. 7B is a view showing an enlarged characteristics of the sensor output during the dead time period;

FIG. 8A is an expanded view showing a partial structure of a PM detection element as a modification of the PM detection element in the PM detection sensor according to the first exemplary embodiment of the present invention;

FIG. 8B is a view showing a cross section of the PM detection element 10a as the modification shown in FIG. 8A;

FIG. 9 is a development view showing a perspective structure of a detection element in a PM detection sensor according to a second exemplary embodiment of the present invention;

FIG. 10A is a schematic view showing equipotential lines and electric lines of force in the detection part of the PM detection sensor according to the second exemplary embodiment of the present invention;

FIG. 10B is a schematic view showing a distribution of electric field intensity in the detection part of the PM detection sensor according to the second exemplary embodiment of the present invention;

FIG. 11A is an expanded view showing a detection element of a PM detection sensor according to a third exemplary embodiment of the present invention;

FIG. 11B is a view showing a cross section of the detection element of the PM detection sensor according to the third exemplary embodiment of the present invention;

FIG. 12A1, FIG. 12B1 and FIG. 12C1 are views showing a schematic cross section of the PM detection sensor according to the third exemplary embodiment and the effects of the PM detection sensor; and

FIG. 12A2, FIG. 12B2 and FIG. 12C2 are views showing a schematic side surface of the PM detection sensor according to the third exemplary embodiment and the effects of the PM detection sensor.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### First Embodiment

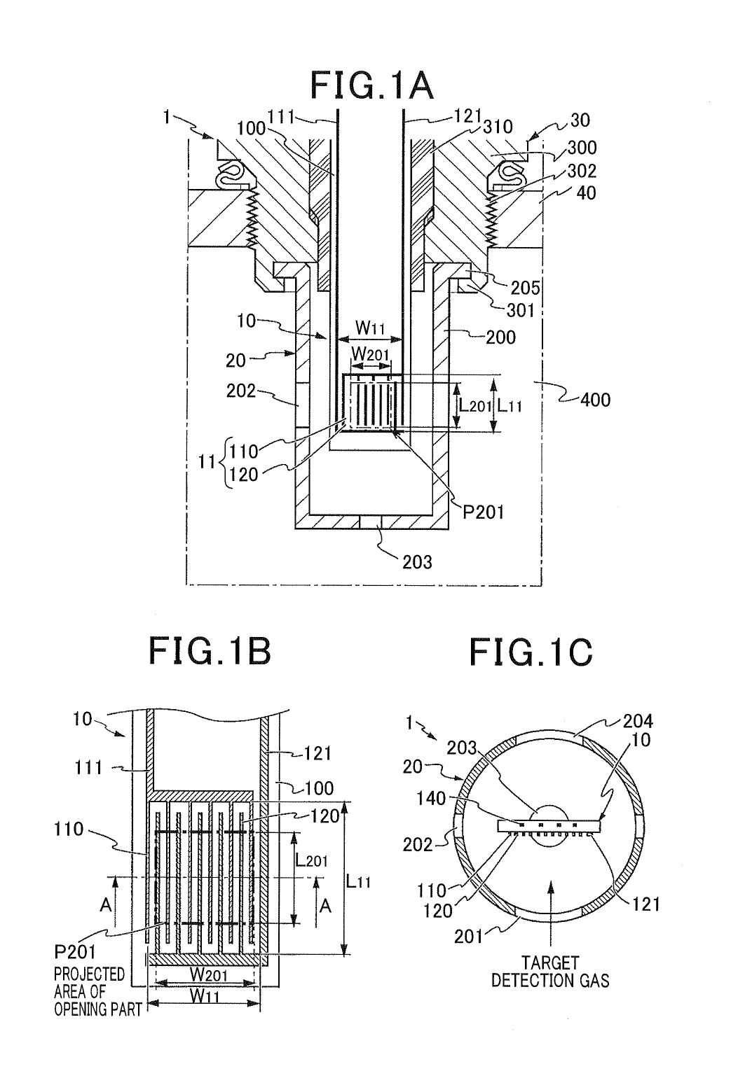

A description will be given of a particulate matter detection sensor 1 (hereinafter, referred to as the “PM detection sensor 1”) according to a first exemplary embodiment of the present invention with reference to FIG. 1A to FIG. 8B.

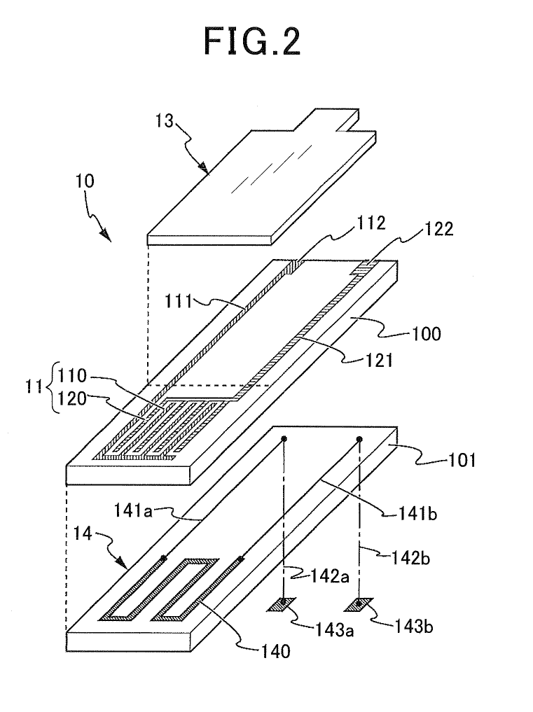

FIG. 1A is a view showing a schematic cross section of a main part of the PM detection sensor 1 according to the first exemplary embodiment. FIG. 1B is a view showing a schematic cross section of a part of the PM detection sensor 1 according to the first exemplary embodiment. FIG. 1C is a view showing a cross section of the PM detection sensor 1 along the A-A line shown in FIG. 1B. FIG. 2 is a development view showing a perspective structure of a PM detection element 10 in the PM detection sensor 1 according to the first exemplary embodiment.

The PM detection sensor according to the first exemplary embodiment can be applied to exhaust gas purifying systems for internal combustion engines. The PM detection sensor detects electrical characteristics such as electrical resistance and electrostatic capacity of a detection part 11 placed in target detection gas such as exhaust gas emitted from an internal combustion engine. The electric characteristics of the detection part 11 are changed according to the change of a quantity of particulate matter (PM) contained in the exhaust gas and accumulated on the area between electrodes of the detection part 11. The PM detection sensor 1 detects a quantity of PM contained in the target detection gas such as exhaust gas on the basis of electrical characteristics of the detection part 11. Specifically, the PM detection sensor 11 is placed at a downstream side of a diesel particulate filter (DPF) in order to detect abnormal state of the DPF. It is also possible to place the PM detection sensor 11 at an upstream side of the DPF in order to directly detect the PM introduced into the DPF.

A description will now be given of the PM detection sensor 1 equipped with a particulate matter detection element (hereinafter, referred to as the “PM detection element 10”) according to the first exemplary embodiment of the present invention with reference to FIG. 1A, FIG. 1B, and FIG. 2.

The PM detection sensor 1 is comprised of a detection part 11 and a cover unit 20. The detection part 11 has a pair of detection electrodes 110 and 120. The detection electrodes 110 and 120 are arranged opposite to each other at a predetermined gap on a surface of a heat resistant substrate 100. The cover unit 20 covers the detection part 11 and has a target detection gas introduction hole 201 through which target detection gas such as exhaust gas is introduced into the inside of the detection part 11. An electrostatic force is generated between the detection electrodes 110 and 120 in the detection part 11. The detection part 11 captures particulate matter (PM) contained in the introduced target detection gas by the electrostatic force generated between the detection electrodes 110 and 120. In general, electrical characteristics of an area between the detection electrodes 110 and 120 are changed according to a change of a quantity of PM accumulated on the area between the detection electrodes 110 and 120. The PM detection sensor 1 detects such a change of the electrical characteristics of the area between the detection electrodes 110 and 120, and detects the presence of PM contained in the target detection gas on the basis of the change of the electrical characteristics of the above area.

It is possible to use an electrical resistance or an electrostatic capacitance of the area between the detection electrodes 110 and 120 which is changed according to the change of a quantity of PM accumulated on the above area. Further, it is also possible to use a change of an impedance of the PM detection element 10 in order to detect the quantity of accumulated PM.

The PM detection sensor 1 according to the first exemplary embodiment has the following structural features. The target detection gas introduction hole 201 is formed so that the target detection gas introduction hole 201 is within the positional range at the inside of the area having a uniform electrical field generated between the detection electrodes 110 and 120 in the detection part 11 when the edge of an opening part of the target detection gas introduction hole 201 is rotated in the circumferential direction in order to be opposite to the detection part 11.

As shown in FIG. 1A, the PM detection sensor 1 is comprised of the PM detection element 10, a sensor fixing part 30 and the cover unit 20. The sensor fixing part 30 supports and fixes the detection part 11 of the PM detection element 10 in the target detection gas 400 introduced in the inside of the PM detection sensor 1. The cover unit 20 covers the PM detection element 10.

The pair of the detection electrodes 110 and 120 in the PM detection sensor 1 is formed on the surface of the heat resistant substrate 100 so that the detection electrodes 110 and 120 are opposite to each other at a predetermined gap. The heat resistant substrate 100 has approximately a plate shape.

As shown in FIG. 1A, FIG. 1B and FIG. 2, the detection electrodes 110 and 120 are comprised of a pair of comb-like electrodes. The comb-like electrodes are alternately arranged in a comb shape on the surface of the heat resistant substrate 100 and formed in parallel along the longitudinal direction of the heat resistant substrate 100. The detection electrodes 110 and 120 are connected to detection lead parts 111 and 121, respectively. The detection lead parts 111 and 121 are connected to an external detection circuit part (omitted from drawings). As shown in FIG. 2, a base part of each of the comb-like electrodes forming the detection electrodes 110 and 120 is bent in the direction which is perpendicular to the longitudinal direction of each of the detection lead parts 111 and 121.

An insulation protection layer 13 is formed or stacked on a part of the surface of the heat resistant substrate 100. The insulation protection layer 13 protects the detection lead parts 111 and 121, and suppresses PM contained in the introduced target detection gas 400 from being accumulated on the part other than the detection part 11.

The PM detection element 10 further has the following structure as shown in FIG. 2. A heating unit 140 is formed on a surface or an inside of a heat resistant substrate 101. A pair of heating-unit lead parts 141a and 141b is formed on the surface of the heat resistant substrate 101. The heating-unit lead parts 141a and 141b are connected to the heating unit 140. Further, through hole electrodes 142a and 143b are formed in the heat resistant substrate 101 so that the through hole electrodes 142a and 143b are penetrated through the heat resistant substrate 101 and connected to the heating unit lead parts 141a and 141b, respectively. The through hole electrodes 142a and 143b are connected to heating-unit electrode terminals 143a and 143b, respectively. The heating-unit electrode terminals 143a and 143b are connected to an external power supply control device (not shown).

The sensor fixing part 30 in the PM detection element 10 is comprised of a cylindrical insulator 310 made of insulation material. The sensor fixing part 30 is supported in the inside of a cylindrical housing 300 made of metal material. The sensor fixing part 30 is fixed in the target detection gas passage 40 by a screw part 302. The screw part 302 is formed at the outer peripheral part of the cylindrical housing 300.

The cover unit 20 is fixed to the front side of the cylindrical housing 300 in order to prevent the PM detection element 10 from being damaged by water and flying fine particles. The detection part 11 is covered with the cover unit 20. This cover unit 20 is comprised of a main cover body 200 of a cylindrical shape with a bottom part, and opening parts 201, 202, 203 and 204, and a flange part 205. As shown in FIG. 1C, the opening parts 201, 202, 203 and 204 are formed in the cover unit 20 so that the target detection gas 400 is introduced into and output from the inside of the PM detection sensor 1 through the opening parts 201, 202, 203 and 204.

The target detection gas introduction hole 201 is formed in the side surface of the main cover body 200, which is opposite to the surface of the detection part 11 of the PM detection element 10. The PM detection element 10 is placed within the range of the opening part of the target detection gas introduction hole 201.

The flange part 205 is formed at the distal end of the cover unit 20. The flange part 205 extends toward the outer radius direction of the cover unit 20 of a cylindrical shape.

A fastening part 301 formed at the front of the cylindrical housing 300 fastens and fixes the flange part 205.

The target detection gas introduction hole 201 is formed in the cover unit 20 so that a projected area of the opening part of the target detection gas introduction hole 201, as designated by the solid line P201 shown in FIG. 1A and FIG. 1B, generated when the target detection gas introduction hole 201 is projected on the detection part 11 is positioned within the inside area surrounded by the outer peripheral zone of the detection electrodes 110 and 120 and the detection electrode lead parts 111 and 121. The projected area of the opening part of the target detection gas introduction hole 201 projected on the detection part 11, designated by the solid line P201 shown in FIG. 1A and FIG. 1B, corresponds to the area surrounded by the edge of the opening part of the target detection gas introduction hole 201 formed in the cover unit 20.

That is, the PM detection sensor 1 according to the first exemplary embodiment has the structure in which the straight-line part of the detection electrodes 110 and 120 formed in parallel along the longitudinal direction of the PM detection element 10 faces the target detection gas introduced through the target detection gas introduction hole 201.

More specifically, as shown in FIG. 1B, the range of the projected area P201 of the opening part of the target detection gas introduction hole 201 is smaller than the range surrounded by the following (1) and (2):

(1) the distance between the detection lead parts 111 and 121 extended in parallel to the longitudinal direction of the PM detection element 10, namely, the wide W11 of the detection part 11 in a direction which is perpendicular to the longitudinal direction of the PM detection element 10; and

(2) the distance between the front end of the detection electrodes 110 and the bottom end of the detection electrodes 120, namely, the length L11 along the longitudinal direction of the PM detection element 10.

That is, as shown in FIG. 1B, the range designated by the horizontal width W201 and the vertical width L201 within the projected area P201 is smaller than the range designated by the horizontal width W11 and the vertical width L11. Only the straight line part of the plurality of the detection electrodes 110 and 120 directly faces the target detection gas 400 introduced through the target detection gas introduction hole 201.

Further, as shown in FIG. 1C, the gas holes 202 are formed at both sides of the cover unit 20. Through the gas holes 202, the target detection gas 400 introduced in the inside of the PM detection element 10 is exhausted to the outside of the cover unit 20.

The pressure adjusting hole 204 is formed at the back surface of the PM detection element 10 so as to introduce and exhaust the target detection gas 400 in order to adjust the pressure of the inside and outside of the cover unit 20. The gas hole 203 is formed at the bottom surface of the cover unit 20. Through the gas hole 203, the target detection gas 400 is exhausted to the front end part of the PM detection sensor 1.

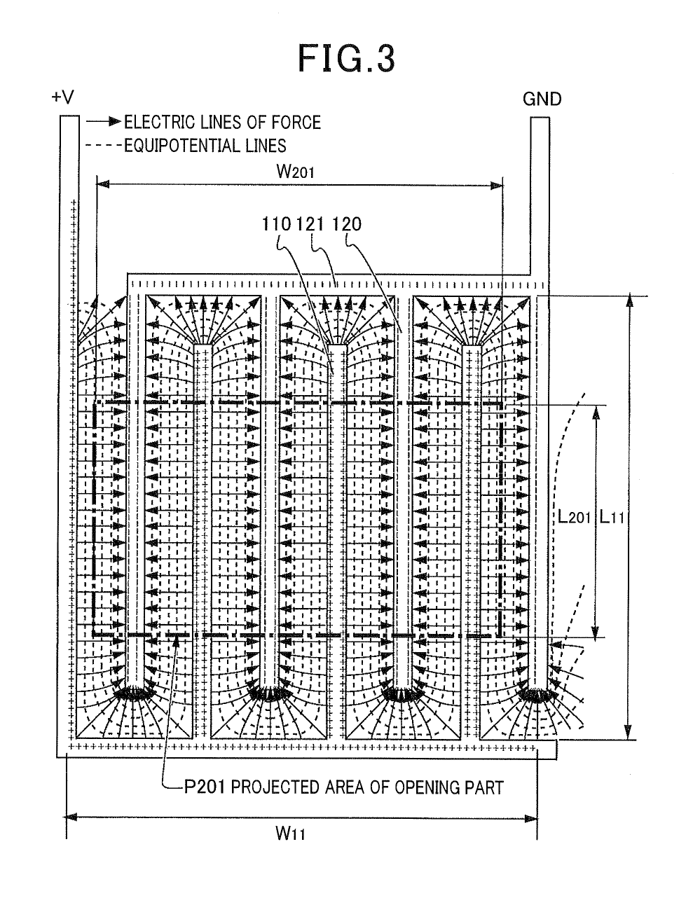

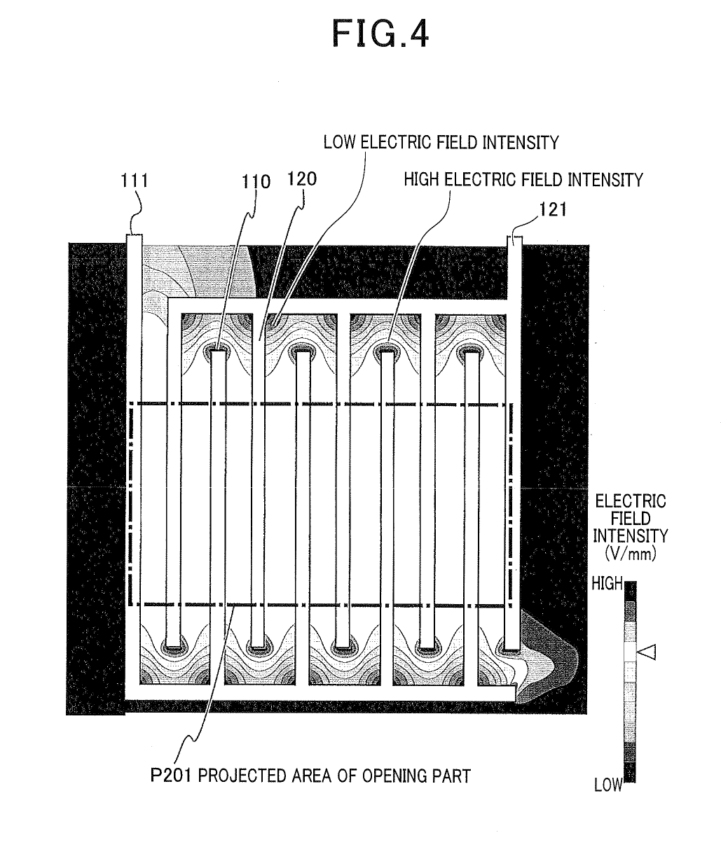

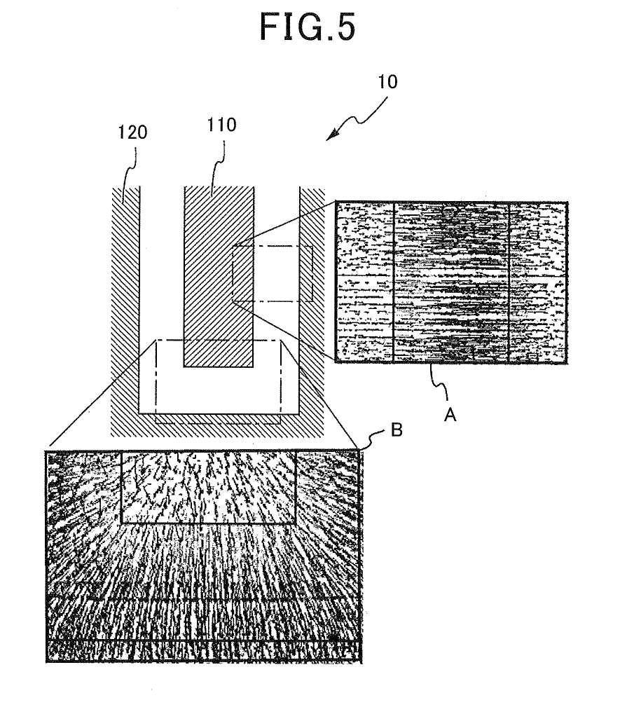

A description will now be given of the operating principles of the PM detection sensor 1 comprised of the PM detection element 10 and the cover unit 20 having the target detection gas introduction hole 201 according to the first exemplary embodiment of the present invention with reference to FIG. 3, FIG. 4 and FIG. 5.

FIG. 3 is a schematic view showing equipotential lines and electric lines of force in the detection part of the PM detection sensor 1 according to the first exemplary embodiment of the present invention when a predetermined voltage +V is supplied between the detection electrodes 110 and 120 of the PM detection element 10 in the PM detection sensor 1. FIG. 4 is a schematic view showing a distribution of electric field intensity in the detection part 11 in the PM detection element 10 in the PM detection sensor 1 according to the first exemplary embodiment of the present invention. FIG. 5 is a view showing electric field vectors in the detection part 11 analyzed by finite element solution.

In particular, FIG. 3 and FIG. 4 shows simulation results when two-dimensional Laplace's equation (∂²U/∂x²+∂²U/∂y²=0) was solved by the difference method.

As shown in FIG. 3 and FIG. 4, the electric field is generated so that the electric potential is gradually decreased from the front of the detection electrode 110, at which the voltage +V is supplied, to the detection electrode 120 which is earthed at the ground voltage GND.

That is, as shown in FIG. 3 and FIG. 4, the electric field vectors are extended radially in the area surrounded by the front part of each detection electrode 110, the detection electrodes 120 which surround the front part of the corresponding detection electrode 110, and the bottom part of the detection electrodes 120 connected to the detection electrode lead part 121. The front part of each detection electrode 110 has the maximum electric field intensity. The bottom part of the electrodes 120 connected to the detection electrode lead part 212 has the minimum electric field intensity.

Similarly, as shown in FIG. 3 and FIG. 4, the electric field vectors are converged in reverse fan-shape, from the detection electrodes 110 to the front part of the detection electrodes 120 in the area surrounded by the front part of each detection electrode 120, the detection electrodes 110 which surround the front part of the corresponding detection electrode 120, and the bottom part of the detection electrodes 110 connected to the detection electrode lead part 111.

The area, in which the straight-line part of the detection electrodes 110 and the straight-line part of the detection electrodes 120 which are formed in parallel, has the uniform electric field intensity. In this area, the electric field vectors extend along a direction which is perpendicular to the edge part, namely, the longitudinal part of the detection electrodes 110 and 120.

Further, the area in the detection part 11 corresponding to the target detection gas introduction hole 201 is within the area having the uniform electric field intensity. This makes it possible for the target detection gas 400 containing PM, introduced into the inside of the cover unit 20 through the target detection gas introduction hole 201, to go straight and to reach the area having the uniform electric file intensity between the detection electrodes 110 and 120 in the detection part 11. The PM contained in the target detection gas 400 is captured by the electrostatic force of the uniform electric field, and accumulated on the area between the detection electrodes 110 and 120.

In particular, because the area between the detection electrodes 110 and 120 in the PM detection element 10 of the PM detection sensor 1 according to the first exemplary embodiment has the uniform electric field intensity, PM with a uniform quantity is accumulated on the area between the detection electrodes 110 and 120.

Still further, even if the target detection gas introduction hole 201 is shifted from a correct position in which the target detection gas introduction hole 201 is opposite to the detection part 11 when the cover unit 20 and the PM detection element 10 are assembled to the sensor fixing part 30, or even if the detection part 11 is shifted, namely, rotated along a circumferential direction, from a correct position in which the detection part 11 directly faces the flow of the target detection gas 400 when the PM detection sensor 1 is placed in the flow of the target detection gas 400, it is possible for the PM detection sensor 1 to execute the stable detection of the presence of PM contained in the target detection gas 400 because the structure of the PM detection sensor 1 prevents the target detection gas 400 from flowing to the area having non-uniform electric field intensity. That is, it is possible to assemble the PM detection sensor 1 having the improved structure to the exhaust gas passage in the exhaust gas purifying system without considering the assemble position in the circumferential direction of the PM detection sensor 1.

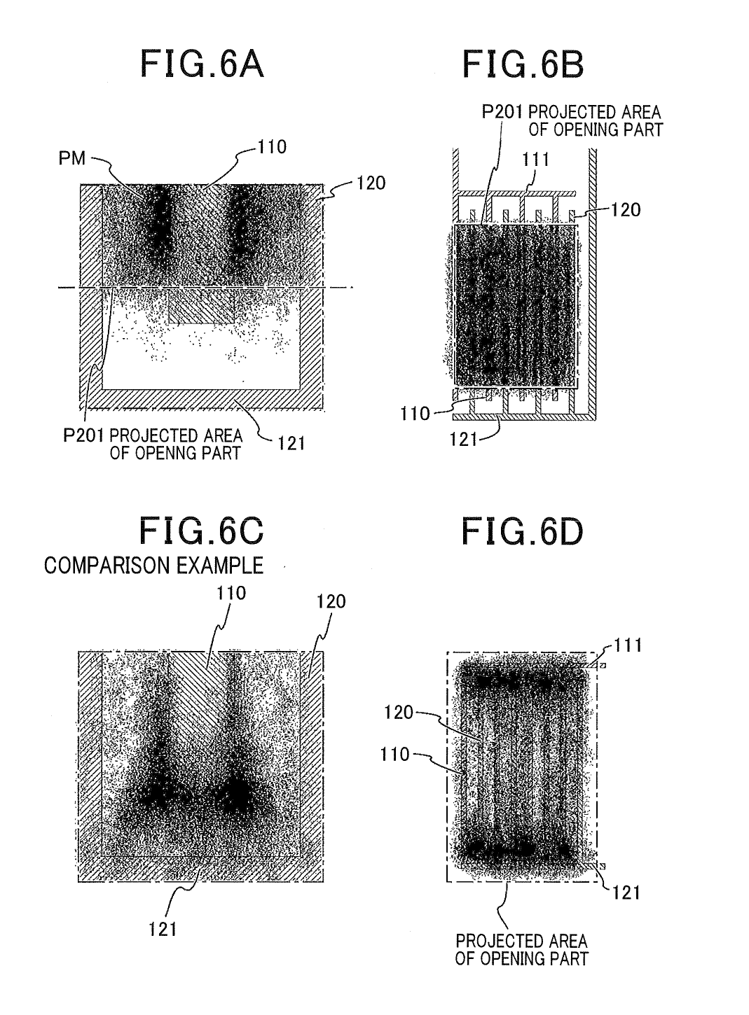

A description will now be given of the effects of the PM detection sensor 1 equipped with the PM detection element 10 according to the first exemplary embodiment with reference to FIG. 6A to FIG. 6D.

FIG. 6A is a schematic view showing PM accumulated on the detection part during a dead time period of the PM detection sensor 1 according to the exemplary embodiment. FIG. 6B is a schematic view showing PM accumulated on the detection part 11 at a completion of a detection period of the PM detection sensor 1 according to the exemplary embodiment. FIG. 6C is a schematic view showing PM accumulated on a detection part of a PM detection sensor as a comparison example. FIG. 6D is a schematic view showing PM accumulated on the detection part at a completion of a detection period of the PM detection sensor as the comparison example.

As shown in FIG. 6A and FIG. 6B, PM is accumulated uniformly around the edges (or side surfaces) of each straight-line part of the detection electrodes 110 in the PM detection element 10 according to the first exemplary embodiment.

Further, as shown in FIG. 6B, when the sensor output of the PM detection sensor 1 is saturated PM detection sensor 1 after elapse of a predetermined time period, the PM is uniformly accumulated on the entire area of the detection electrodes 110 and 120 in the detection part 11. This entire area of the detection electrodes 110 and 120 corresponds to the target detection gas introduction hole 201 through which the target detection gas 400 is introduced into the inside of the PM detection sensor 1.

On the other hand, as shown in FIG. 6C and FIG. 6D, when the PM detection sensor as a comparison example having a target detection gas introduction hole whose opening area is larger than the area of the detection part 11. As shown in FIG. 6C, PM is locally accumulated at the front part of the detection electrode 110 during a dead time period. The distribution of the PM accumulated at the front part of the detection electrode 110 corresponds to the distribution of the electric field intensity. Further, as shown in FIG. 6D, a large quantity of PM is accumulated at the area in which the front part of the detection electrodes 110 and 120 faces the detection electrode lead parts 121 and 111, and less quantity of PM is accumulated on the area between the straight line parts of the detection electrodes 110 and 120 formed in parallel. It is assumed that a large part of PM is accumulated on the area having a high electric field intensity between the detection electrodes 110 and 120, and the electrical resistance between the detection electrodes 110 and 120 is suddenly decreased, and the decreased electrical resistance exceeds a threshold value as a detection limit value.

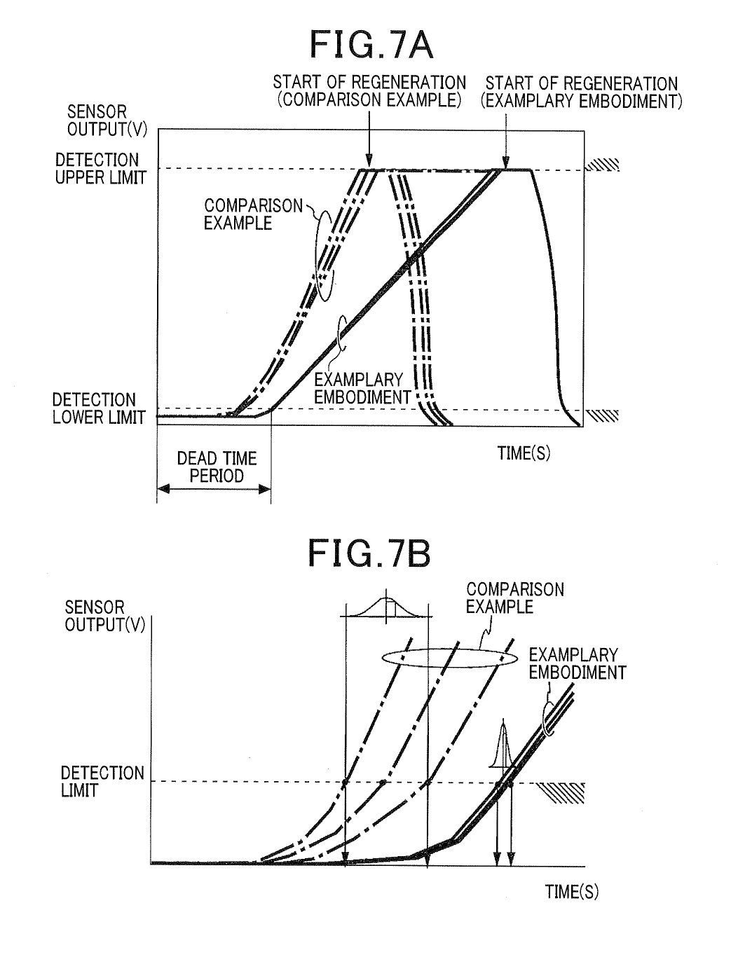

A description will now be given of the experimental results showing the effects of the PM detection sensor 1 equipped with the PM detection element 10 according to the first exemplary embodiment with reference to FIG. 7A and FIG. 7B.

FIG. 7A is a view showing a characteristic change of a sensor output supplied from the PM detection sensor 1 with passage of time. FIG. 7B is a view showing an enlarged characteristics of the sensor output of the PM detection sensor 1 during the dead time period.

As shown in FIG. 7A, the PM detection sensor 1 output a sensor signal (hereinafter, referred to as the “sensor output”). The sensor output of the PM detection sensor 1 has a low rising speed and is within a narrow fluctuation. Therefore the PM detection sensor 1 has a long period of time until the regeneration process of the PM detection sensor 1 when compared with that of a conventional PM detection sensor.

That is, the comparison sample has a fast rising speed of the sensor output, and a large fluctuation. Therefore the comparison sample as the conventional PM detection sensor has a short period of time until the regeneration process of the PM detection sensor when compared with that of the PM detection sensor 1 according to the first exemplary embodiment.

The dead time period of the PM detection sensor is a period of time until the PM detection sensor starts to output its sensor signal to an external device, for example, until an electric control unit detects the sensor output.

As shown in FIG. 7B, although the PM detection sensor 1 has a long dead time period, when compared with the dead time period of the comparison sample, the PM detection sensor 1 has a low fluctuation and a constant dead time period.

On the other hand, although the comparison sample outputs sensor output early, when compared with that of the PM detection sensor 1, the comparison sample has a large fluctuation and a fluctuation period is not stable.

This means that the PM detection sensor 1 according to the first exemplary embodiment has a stable sensor output because PM contained in the target detection gas 400 such as exhaust gas is captured only by and accumulated only on the area having the uniform electric field intensity. Further, because the PM is uniformly accumulated on the area in which the straight line part of each of the detection electrodes 110 and 120 formed in parallel, the time to detect the sensor output from the PM detection sensor 1 becomes long when compared with that from the comparison sample.

By the way, in the structure of the comparison sample, PM is accumulated on an area having high electric field intensity between the detection electrodes, and the sensor output of the comparison sample is therefore detected early. However, because PM is locally accumulated on the area having the high electric field intensity, the distribution of PM accumulated on the area between the detection electrodes is not uniform and fluctuated. Still further, because PM is locally accumulated on the area between the detection electrodes, it can be considered that a conduction path having a low electric resistance is formed in an early stage.

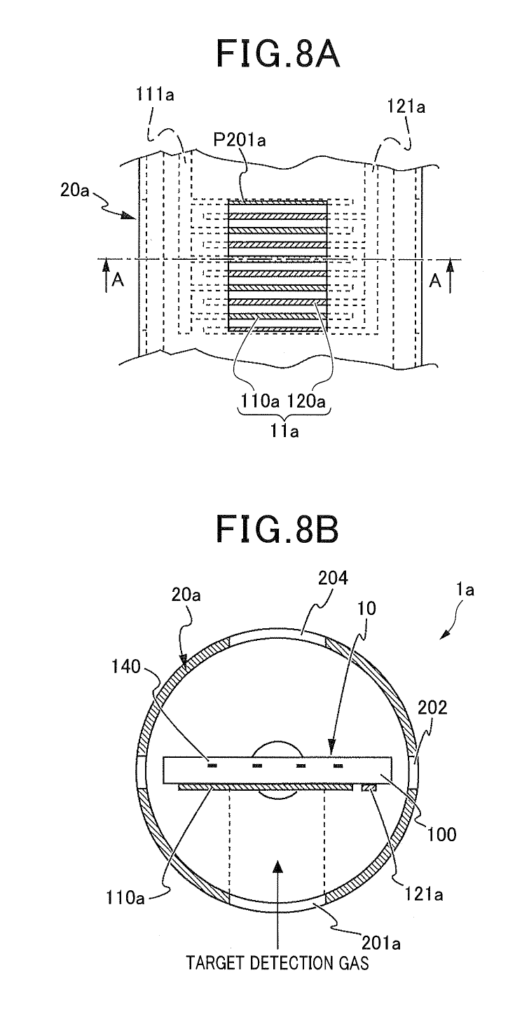

A description will now be given of the PM detection element 10a as a modification of the PM detection element 10 with reference to FIG. 8A and FIG. 8B.

FIG. 8A is an expanded view showing a partial structure of the PM detection element 10a as a modification of the PM detection element 10 of the PM detection sensor according to the first exemplary embodiment. FIG. 8B is a view showing a cross section of the PM detection element 10a as the modification shown in FIG. 8A.

The same components between the first exemplary embodiment shown in FIG. 1A, FIG. 1B and FIG. 1C and the modification shown in FIG. 8A and FIG. 8B are designated by the same reference numbers.

The first exemplary embodiment shows the structure in which the detection electrodes 110 and 120 are formed in parallel along the longitudinal direction of the PM detection element 10.

On the other hand, the modification has the structure in which the detection electrodes 110a and 120a are formed in a direction which is perpendicular to the longitudinal direction of the PM detection element 10a. In the structure of the PM detection sensor 1a equipped with the PM detection element 10a as the modification shown in FIG. 8A and FIG. 8B, the opening part of a target detection gas introduction hole 201a corresponds to the specified range of the detection unit 11a of the PM detection element 10a.

In the structure of the modification of the PM detection element shown in FIG. 8A and FIG. 8B, the detection electrodes 110a and 120a are comprised of a pair of comb-like electrodes. The comb-like electrodes are alternately arranged on the surface of the heat resistant substrate 100 and formed in parallel along the longitudinal direction of the heat resistant substrate 100. The detection electrodes 110a and 120a are connected to detection lead parts 111a and 121a, respectively. The detection lead parts 111a and 121a are connected to an external detection circuit part (omitted from drawings). As shown in FIG. 2, a base part of each of the comb-like electrodes forming the detection electrodes 110 and 120 is bent in the direction which is perpendicular to the longitudinal direction of each of the detection lead parts 111a and 121a.

Still further, the target detection gas introduction hole 201a is formed in the cover unit 20a so that the projected area P201a of the opening part of the target detection gas introduction hole 201a, which is projected on the detection part 11a, is positioned within the inside area surrounded by the outer peripheral zone of the detection electrodes 110a and 120a and the detection electrode lead parts 111a and 121a. The projected area P201a of the opening-part projected on the detection part 11a corresponds to the area surrounded by the edge of the opening part of the target detection gas introduction hole 201a formed in the cover unit 20a. That is, the PM detection sensor 1a as the modification of the first exemplary embodiment has the structure in which the straight-line part of the detection electrodes 110a and 120a formed in parallel to each other along the longitudinal direction of the PM detection element 10a faces the target detection gas introduced through the target detection gas introduction hole 201a.

Because the detection part 11a has the uniform electric field intensity and faces the target detection gas introduction hole 201a, PM contained in the target detection gas 400 introduced through the target detection gas introduction hole 201a is directly collided with the detection part 11a. PM contained in the target detection gas is captured by and accumulated on the detection part 11a having the uniform electric field intensity. Therefore the PM detection sensor 1a as the modification has the same effects of the PM detection sensor 1 according to the first exemplary embodiment.

### Second Exemplary Embodiment

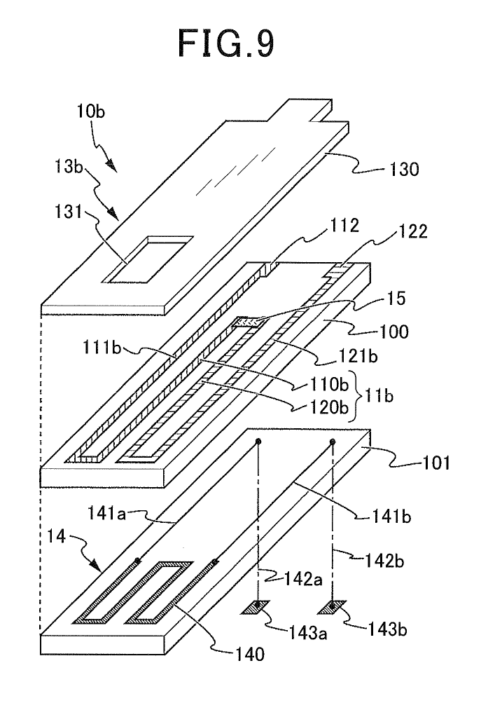

A description will now be given of a PM detection sensor 1b according to the second exemplary embodiment of the present invention with reference to FIG. 9.

FIG. 9 is a development view showing a perspective structure of a detection element 10b in the PM detection sensor 1b according to the second exemplary embodiment of the present invention.

Each of the PM detection sensor 1 according to the first exemplary embodiment and the PM detection sensor 1a as the modification has the detection part 11 (11a) composed of the detection electrodes 110 (110a) and 120 (120a) arranged in a comb structure.

On the other hand, the PM detection sensor 1b according to the second exemplary embodiment has the detection par 11b in which a pair of detection electrodes 110b and 120b is formed at a predetermined constant interval in parallel on the heat resistant substrate 100 along the longitudinal direction of the heat resistant substrate 100. In the PM detection sensor 1b, the detection part 11b is formed in the inside area between the pair of the detection electrodes 11b and 120b which face to each other.

As shown in FIG. 9, a base part of each of the detection electrodes 110b and 120b is bent in the direction which is perpendicular to the longitudinal direction of the detection part 11b. The bent part of each of the detection electrodes 110b and 120b is connected to each of the detection lead parts 111b and 121b, respectively. Further, the detection lead parts 111b and 121b are formed parallel to the detection electrodes 110b and 120b along the longitudinal direction of the detection part 11b. The detection lead parts 111b and 121b are formed outside of the detection electrodes 110b and 120b, and connected to the external detection circuit (not shown).

Further, a passive element 15 is formed between one end part of the detection electrode 110b and one end part of the detection electrode 120b so that the passive element 15 connects the detection electrode 110b and the detection electrode 120b together in series.

It is possible to use, as the passive element 15, one of a resistance element having a predetermined resistance and a capacitance element having a predetermined electrostatic capacity.

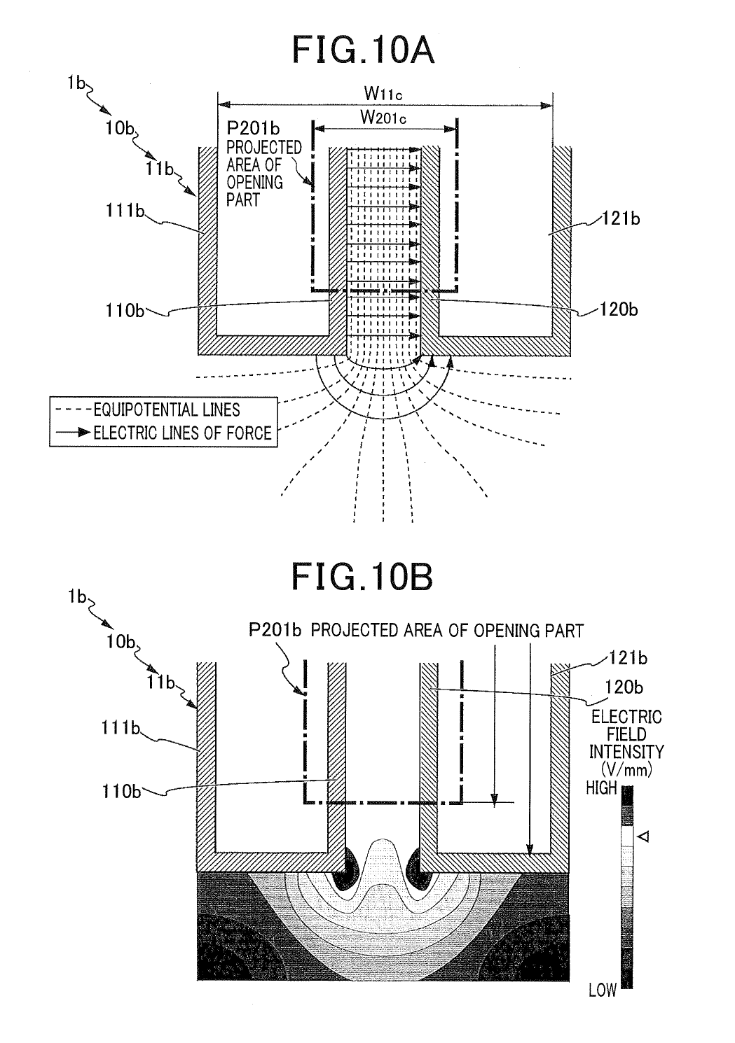

In the structure of the PM detection sensor 1b according to the second exemplary embodiment as shown in FIG. 10A and FIG. 10B, the projected part P201b, as designated by the alternate long and dash line P201b, of the opening part of the target detection gas introduction hole 201b, is positioned within the area surrounded by the straight-line parts of the detection electrodes 110b and 120b formed in parallel to each other, other than the bent part of each of the detection electrodes 110b and 120b and the passive element 15 through which the detection electrodes 110b and 120b are connected. That is, the projected area P201b of the opening part of the target detection gas introduction hole 201b projected on the detection part 11b faces the target detection gas introduction hole 201b formed in the cover unit 20. The projected area P201b, as designated by the alternate long and dash line P201b, of the opening part of the target detection gas introduction hole 201b is positioned within the inside area surrounded by the outer peripheral zone of the detection electrodes 110 and 120 and the detection electrode lead parts 111 and 121 on the detection part 11b. The projected area P201b of the opening part projected on the detection part 11b, as designated by the solid line P201 shown in FIG. 10A and FIG. 10B, corresponds to the area surrounded by the edge of the opening part of the target detection gas introduction hole 201 formed in the cover unit 20. That is, the PM detection sensor 1 according to the second exemplary embodiment has the structure in which the straight-line part of the detection electrodes 110b and 120b formed in parallel to each other along the longitudinal direction of the PM detection element 10b faces the target detection gas introduced through the target detection gas introduction hole 201b formed in the cover unit 20. This makes it possible to supply the target detection gas 400 containing PM directly to the inside area between the detection electrodes 110b and 120b formed parallel to each other.

FIG. 10A is a schematic view showing equipotential lines and electric lines of force in the detection part 11b of the PM detection sensor 1b according to the second exemplary embodiment of the present invention. FIG. 10B is a schematic view showing a distribution of electric field intensity in the detection part of the PM detection sensor 1b according to the second exemplary embodiment of the present invention.

As shown in FIG. 10A and FIG. 10B, the PM detection sensor 1b according to the second exemplary embodiment has the same effects of the PM detection sensor 1 according to the first exemplary embodiment because the PM detection sensor 1b has the detection electrodes 110b and 120b of a straight line shape formed in parallel along the longitudinal direction of the detection part 11b, the inside area surrounded by the detection electrodes 110b and 120b has a uniform electric field intensity, and PM contained in the target detection gas 400 is introduced only to the inside area and captured by and accumulated on the inside area between the detection electrodes 110b and 120b.

Still further, because the detection electrodes 110b and 120b forming the pair electrode are connected in series through the passive element 15 when no PM is accumulated on the detection part 11b, it is possible to detect occurrence of breaking wires by detecting the resistance value or the electrostatic capacitance of the passive element 15, where these wires are connected to the detection electrodes 110b and 120b and the detection electrode lead parts 111b and 121b. This makes it possible to provide the PM detection sensor with more high accuracy.

It is possible to cover the PM detection element 10 by a cover unit of triple layers instead of the cover unit 20 of a single layer.

Further, it is possible for the PM detection sensor to have a plurality of cover units in order to suppress influence of temperature change of the environment in which the PM detection sensor is placed. In this case, when the PM detection sensor has a complicated gas introduction passage, the flow speed of the target detection gas is rapidly decreased, and the complicated gas introduction passage prevents the target detection gas from flowing directly to the detection part of the PM detection element, and this structure makes it easy to attract the target detection gas to the area having a high electric field intensity. This decreases the effects of the present invention previously described.

### Third Exemplary Embodiment

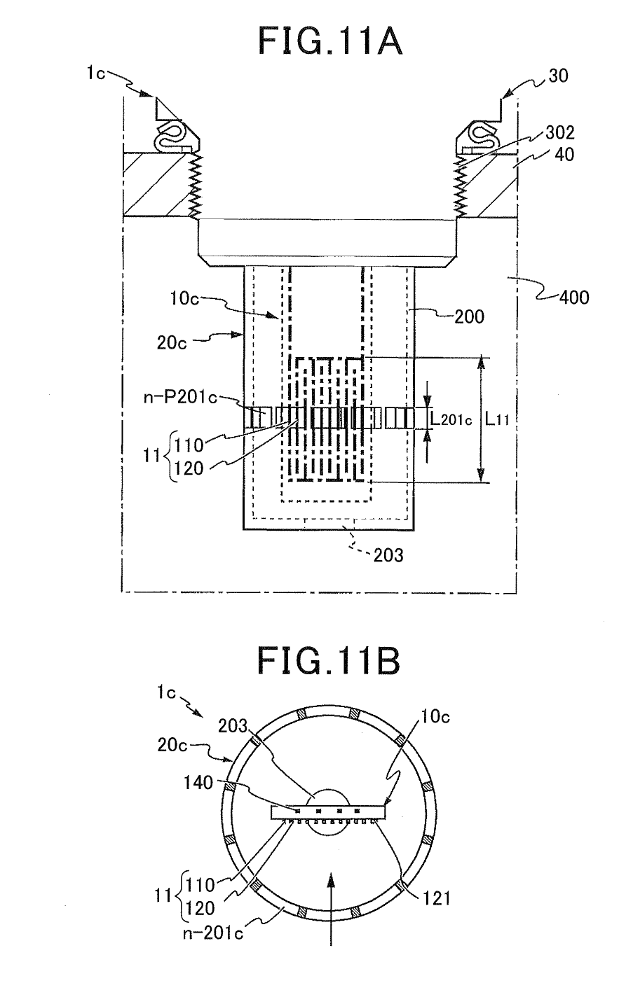

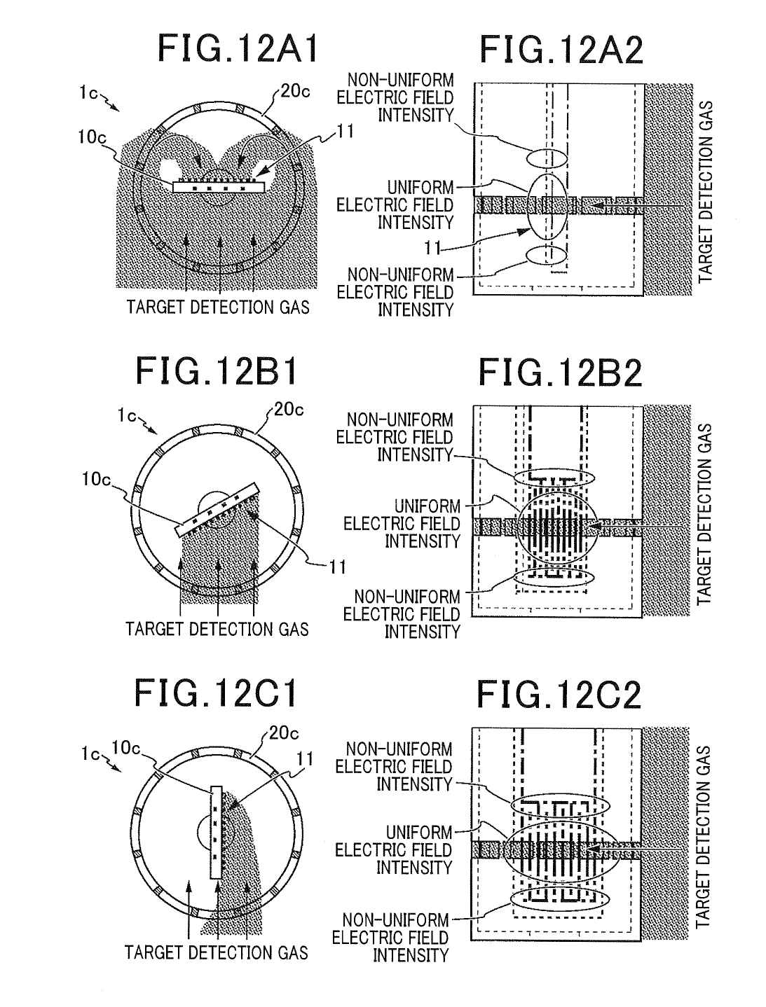

A description will now be given of a PM detection sensor 1c according to the third exemplary embodiment of the present invention with reference to FIG. 11A, FIG. 11B, FIG. 12A1, FIG. 12A2, FIG. 12B1, FIG. 12B2, FIG. 12C1 and FIG. 12C2.

FIG. 11A is an expanded view showing the PM detection element 10c of the PM detection sensor 1c according to the third exemplary embodiment of the present invention. FIG. 11B is a view showing a cross section of the detection element 10c of the PM detection sensor 1c according to the third exemplary embodiment. FIG. 12A1, FIG. 12B1 and FIG. 12C1 are views showing a schematic cross section of the PM detection sensor 1c according to the third exemplary embodiment and the effect of the PM detection sensor 1c. FIG. 12A2, FIG. 12B2 and FIG. 12C2 are views showing a schematic side surface of the PM detection sensor 1c according to the third exemplary embodiment and the effect of the PM detection sensor 1c.

In the first and second embodiments, as previously described, the single target detection gas introduction hole is formed in the cover unit of the PM detection sensor so that the projected area of the opening part of the target detection gas introduction hole projected on the detection part is within the area having the range of a uniform electric field intensity. This makes it possible for the target detection gas introduction hole to face directly to the detection part.

In the third embodiment, as shown in FIG. 11A and FIG. 11B, the detection electrodes 110 and 120 are formed in parallel along the longitudinal direction of the detection element 10c, like the structure of the first exemplary embodiment. In addition to this structure, a plurality of target detection gas introduction holes 201c is formed at a uniform interval along the circumferential direction of the cover unit 20c, and the length L_{201c} of the opening part of the target detection gas introduction hole 201c is adequately smaller than the vertical length L₁₁ of the detection part 11 shown in FIG. 11A. Even if the detection part 11c is positioned opposite to the direct flow of the target detection gas introduced through the target detection gas introduction holes 201c shown in FIG. 12A1, it is possible for the target detection gas 400 to collide with the back surface of the detection part 10c to swirl and to flow to the front surface of the detection part 11 on which the detection electrodes 110 and 120 are formed in parallel. PM contained in the target detection gas 400 is finally accumulated.

In this structure shown in FIG. 12A1 and FIG. 12A2, because the length L_{201c} of the opening part of the target detection gas introduction hole 201c is adequately smaller than the vertical length L₁₁ of the detection part 11c, no target detection gas flows only into the area having a uniform electric field intensity, and not into the area having non-uniform electric field intensity. This makes it possible for the PM detections sensor 1c to provide a stable sensor output to the external detection circuit (not shown).

Further, as shown in FIG. 12B1, even if the detection part 10c is placed at a rotated and inclined position to the flow of the target detection gas in the circumferential direction, it is possible to introduce the target detection gas into the area having an uniform electric field intensity as shown in FIG. 12B2.

Still further, as shown in FIG. 12C1, even if the detection part 10c is positioned approximately parallel to the flow of the target detection gas, it is possible to introduce the target detection gas into the area having an uniform electric field intensity, and not to pass through the area having non-uniform electric field intensity, as shown in FIG. 12B2. In this case, when the target detection gas flows in the area having the uniform electric field intensity in the detection part 11c, PM contained in the target detection gas is attracted by the electric field generated between the detection electrodes 110 and 120, and the PM is accumulated only on the area having the uniform electric field intensity.

As previously described in detail, even if the detection part 11c is placed at a variable angle to the target detection gas introduction holes 201c, it is possible for the PM detection sensor according to the third exemplary embodiment to have the effects of the present invention.

Further, the structure of the PM detection sensor 1c according to the third exemplary embodiment cannot be applied to the structure of the PM detection sensor 1a as a modification shown in FIG. 8A and FIG. 8B, in which the detection electrodes 110a and 120a are formed in a direction which is perpendicular to the longitudinal direction of the detection element 10a.

On the other hand, the structure of the PM detection sensor 1c according to the third exemplary embodiment can be applied to the structure of the PM detection sensor 1 according to the secondary exemplary embodiment shown in FIG. 9.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. A particulate matter detection sensor capable of detecting particulate matter contained in a target detection gas, comprising:
a heat resistant substrate;
a detection part comprised of a pair of detection electrodes formed at a predetermined interval on a surface of the heat resistant substrate; and
a cover unit in which a target detection gas introduction hole is formed, through which the target detection gas is introduced into the detection part while protecting the detection part,
wherein particulate matter contained in the target gas is captured on the detection part by electrostatic force generated between the detection electrodes, and the presence of particulate matter contained in the target detection gas is detected on the basis of a change of electric characteristics of the detection part when particulate matter is accumulated on an area between the detection electrodes in the detection part, and
the target detection gas introduction hole is formed in the cover unit so that a projected area of the target detection gas introduction hole generated when the target detection gas introduction hole is projected onto the detection part is positioned within the inside of an area having a uniform electric field intensity generated between the pair of the detection electrodes.

2. The particulate matter detection sensor according to claim 1, wherein the pair of the detection electrodes has one of structures (a) and (b):
(a) the detection electrodes has a comb structure in which electrodes are alternately arranged in parallel along a longitudinal direction of the heat resistant substrate, and are formed along a direction which is perpendicular to a pair of detection electrode lead parts, and the detection electrode lead parts are connected to an external detection circuit; and
(b) the detection electrodes has a comb structure in which electrodes are alternately arranged in parallel to each other along a longitudinal direction of the heat resistant substrate, and the plural electrodes are connected to a bent part of each of a pair of detection electrode lead parts, and the bent part of each of the detection electrode lead parts is bent in a direction which is perpendicular to the longitudinal direction of the heat resistant substrate, and the detection electrode lead parts are connected to an external detection circuit,
wherein the projected area of the target detection gas introduction hole projected on the detection part is positioned within the inside of an area formed by a front part of one detection electrode and the connection part between the other detection electrode and the corresponding detection electrode lead part so that the target detection gas is introduced onto the area in which straight line parts of the detection electrodes are arranged in parallel.

3. The particulate matter detection sensor according to claim 1, wherein the pair of the detection electrodes is formed extending in parallel on the heat resistant substrate at a predetermined interval along the longitudinal direction of the heat resistant substrate,
at least the inside area between the pair of the detection electrodes is used as the detection part, and one end part of each of the detection electrodes is bent, and the bent part of each of the detection electrodes is connected to a corresponding detection electrode lead part, the pair of the detection electrode lead parts is formed at the outside of the pair of the detection electrodes formed in parallel on the heat resistant substrate, and the pair of the detection electrode lead parts are connected to an external detection circuit, and
the projected area of the target detection gas introduction hole generated when the target detection gas introduction hole is projected onto the detection part is positioned within the inside of an area surrounded by straight line parts of the pair of the detection electrodes excepting the bent part of each of the detection electrodes and the pair of the detection electrode lead parts, and the target detection gas is introduced into the inside of the straight line parts of the detection electrode formed in parallel.
